(19) United States
(12) Patent Application Publication
(10) Pub. No.: US 2012/0152980 A1
(43) Pub. Date: Jun. 21, 2012

(54) Jen's 2 in 1

(76) Inventor: Jennifer Maurer, Blue Bell, PA (US)

(21) Appl. No.: 13/373,943

(22) Filed: Dec. 5, 2011

Related U.S. Application Data
(60) Provisional application No. 61/458,958, filed on Dec. 3, 2010.

(51) Int. Cl. B67D 7/74

(52) U.S. Cl. 222/129

(57) ABSTRACT

The invention provides a storage container with two separate dispensers incorporated into its design. This device will make traveling easier, as well as reduce bathroom clutter. Fabricated of a squeezable recycled plastic material, this product comprises an elongated round or oval shaped unit comprised of two chambers positioned one atop the other. Jen's 2 in 1 is produced in a variety of sizes to accommodate products contained within. Appropriates size are approximately four to twelve inches in height and two to six inches in width. Both ends of the unit are flat, thus this container easily stands upright when stored resting on the top or the bottom. As mentioned, Jen's 2 in 1 is divided in half at the center of the unit by means of a plastic partition, thus creating two separate chambers for storing two different products.

### CLAIM OF PRIORITY

This patent application claims priority under 35 USC 119 (e) (1) from U.S. Provisional Patent Application Ser. No. 61/458,958 filed Dec. 3, 2010, of common inventorship herewith entitled, “Jen's 2 in 1.”

### FIELD OF THE INVENTION

The present invention pertains to the field of container dispenser and more specifically to the field of container dispenser for health and beauty liquids.

### BACKGROUND OF THE INVENTION

The prior art has put forth several designs for container dispensers storage. Among these are:

U.S. Pat. No. 4,239,131 to Ken Emert and Dan Rogers describes a self-priming liquid dispenser comprising a container having an opening in its top by which it may be filled with liquid and an opening in its bottom through which the liquid may be expelled.

U.S. Pat. No. 5,044,522 to Miguel Roig and George Spector describes a shower dispenser comprising a container which can be suspended from a shower head arm having a plurality of side by side compartments, each having a nozzle for dispensing different liquids.

U.S. Pat. No. 5,413,251 to David J. Adamson describes a liquid dispensing with dual reservoir delivery system incorporating a housing for mounting on a shower, bath enclosure or other appropriate wall, wherein the housing comprises a plurality of refillable and sealable bottles that conform to the interior contour of the housing.

None of these prior art references describe the present invention.

### SUMMARY OF THE INVENTION

It is an object of the present invention to provide an improved container for dispensing a plurality of liquids

### BRIEF DESCRIPTION OF THE DRAWINGS

FIG. 1 is a front perspective view of two examples of the present invention. One example shows the container being used for shampoo and conditioner. The other example shows the container being used for face sunscreen, and SPF 15 sunscreen.

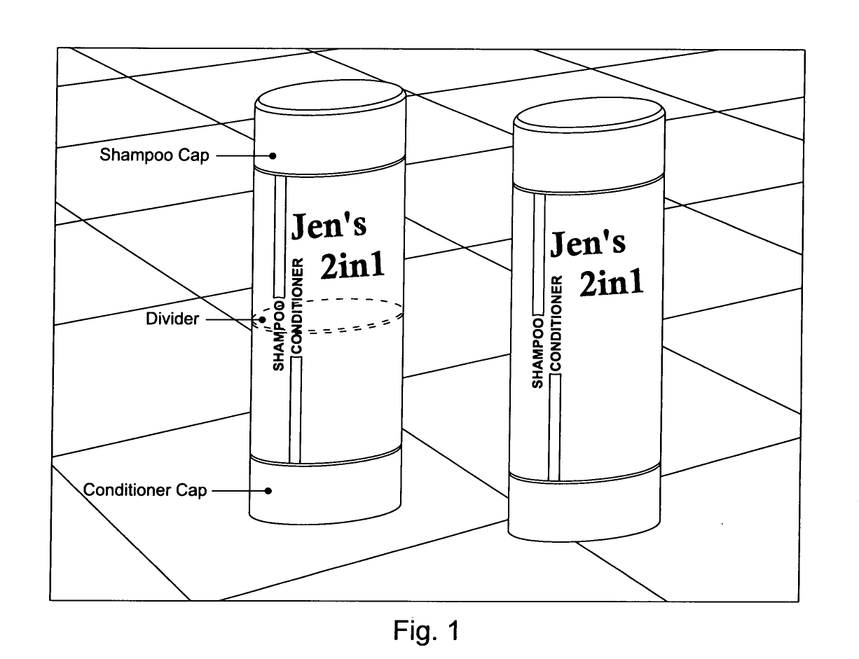

### DETAILED DESCRIPTION OF THE INVENTION

The present invention provides a single container capable of holding and dispensing two products. This provides for increased neatness and efficiency when utilizing more than one product. Use of the present invention prevents the use from handling two separate bottles for their needs.

With the demand for bath products continually on the rise, finding ample storage space has become a challenge in most households. Specifically, while soap dishes are incorporated into the design of most bath tubs and shower stalls, finding adequate room for shampoo and conditioner products can be problematic. Lined on the edge of the top of the tub or placed on the floor inside the shower, these products can create excess clutter. However, cluttering these areas in such a manner can be quite dangerous, since these items can easily be knocked over or stepped on when entering the shower or while bathing. As a result, a safety hazard is created since these products, if spilled, can make a wet tile, porcelain, or plastic surface extremely slippery.

Recognizing the need for a product which keeps the shower area free of clutter and products safely stored while still within reach, the present invention, hereinafter referred to as Jen's 2 in 1, was developed. Simply stated, Jen's 2 in 1 is a specially designed storage container with two separate dispensers incorporated into its design. This device will make traveling easier, as well as reduce bathroom clutter.

Jen's 2 in 1 can be utilized by manufactures of health and beauty aids as a clever packaging enhancement which appeals to customers. This product can also be sold as an aftermarket accessory to be filled by the consumer as desired. Fabricated of a squeezable recycled plastic material, this product comprises an elongated round or oval shaped unit comprised of two chambers positioned one atop the other. Jen's 2 in 1 is produced in a variety of sizes to accommodate products contained within. Appropriates size are approximately four to twelve inches in height and two to six inches in width. Both ends of the unit are flat, thus this container easily stands upright when stored resting on the top or the bottom. As mentioned, Jen's 2 in 1 is divided in half at the center of the unit by means of a plastic partition, thus creating two separate chambers for storing two different products. For instance, the first dispenser can be utilized to store shampoo while the second can store conditioner. Not only for hair products, the present invention is also useful various skin products, also. Some examples include, for example, sunscreen, having SPF 15 for the body in the first chamber, and sunscreen having SPF 45 for face in the second chamber. Another example includes facial care, such as cleanser in the first chamber and moisturizer in the second chamber. Another example would be body lotion in the first chamber and facial moisturizer in the second chamber. This compartmented packaging enhancement can also store any number of other products in its upper and lower dispensers. Positioned at each end of the unit is a removable threaded cap, with which the user can use to refill the device, as well dispense the products.

Use of Jen's 2 in 1 is very simple and straightforward. First, the user purchases their favorite health and beauty aids packaged within this handy container. For instance, for daily use, one may utilize a Jen's 2 in 1 filled with shampoo and conditioner. Alternately, a beach goer may purchase a Jen's 2 in 1 filled with SPF 45 sun block for the kids on one side of the device, while the opposite side is filled with SPF 8 facial sun block. Use of Jen's 2 in 1 simply involves opening the desired compartment's easy pour spout and dispensing the product as needed. When all of the contents of Jen's 2 in 1 have been depleted, the user simply rinses the unit clean and refills the device with their favorite health and beauty aids, reusing the container indefinitely.

There are several significant benefits and advantages associated with Jen's 2 in 1. Foremost, this cleverly designed two-in-one dispenser mechanism provides consumers a practical and organized means of storing a myriad of health or beauty products. A cleverly designed packaging enhancement, Jen's 2 in 1 provides consumers with a simple yet effective method of organizing the shower area, and minimizing containers for travel. While providing orderly storage, Jen's 2 in 1 also keeps the shower area safe. With a myriad of bottles eliminated, the top of the tub and floors of the shower are kept clear, a benefit which is especially important to households with small children. In addition, the easy to use squeezable bottle allows users to have the liquid in the palm of their hand in a matter of seconds. This feature is especially beneficial to the elderly and consumers with limited physical capabilities, as they do not have to wrestle with unwieldy and heavy bottles. Not just for household users, hospitals and lodging establishments will certainly appreciate the convenience this product affords patients and guests. Further, Jen's 2 in 1 will especially appeal to busy travelers, as this unique dispenser takes up little space in suitcases, travel bags or beach bags. With a wide variety of products suitable for packaging in Jen's 2 in 1, for practical uses of this unique storage receptacle are virtually limitless. Manufactured of recycled materials and reusable, Jen's 2 in 1 provides an environmentally friendly alternative to utilizing a bottle of shampoo or sun block and then discarding the plastic container in the trash. Used indefinitely, this handy container provides consumers a simple step they can take in protecting the earth's fragile ecosystem.

The present invention will also appeal to “big box” stores or for companies that want to market their product s in Jen's 2 in 1. This will provide consumers with more choice when selecting health and beauty products.

Jen's 2 in 1 is an innovative product invention which improves bathroom safety and facilitates cleaning. Cleverly designed, this handy product creates a more organized bathing space, simplifying and improving the quality of refreshing daily showering routines, while also serving a variety of other useful applications.

Affordably priced, Jen's 2 in 1 will be well received by the vast majority of household consumers.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A dispenser container device having a duality of storage compartments, comprising: an essentially cylindrical container having two separate compartments, one on top of the other, divided by a partition and having a removable threaded cap on the top portion and a removable threaded cap on the bottom portion.

2. The container device of claim 1 fabricated of a squeezable recycled plastic material.

3. The container device of claim 1, wherein the removable threaded cap further comprises a snap top opening top dispense liquid contents.

4. The container device of claim 1 produced in a variety of sizes to accommodate products contained within.

5. The container device of claim 3 wherein the sizes are approximately four to twelve inches in height and two to six inches in width.
